(19) United States
(12) Patent Application Publication
(10) Pub. No.: US 2020/0145635 A1
(43) Pub. Date: May 7, 2020

(54) INFORMATION PROCESSING APPARATUS, INFORMATION PROCESSING METHOD AND STORAGE MEDIUM

(71) Applicant: CANON KABUSHIKI KAISHA, Tokyo (JP)

(72) Inventor: Keigo Yoneda, Yokohama-shi (JP)

(21) Appl. No.: 16/661,382

(22) Filed: Oct. 23, 2019

(30) Foreign Application Priority Data
Nov. 6, 2018 (JP) 2018-208993

(51) Int. Cl. H04N 13/117; H04N 13/282; H04N 13/167; H04N 5/247; H04N 5/44

(52) U.S. Cl. CPC H04N 13/117; H04N 13/282; G06F 3/0338; H04N 5/247; H04N 5/4403; H04N 13/167

(57) ABSTRACT

An information processing apparatus including: a reception unit configured to receive an input in accordance with a specific user operation for changing a position of a virtual viewpoint for a virtual viewpoint image; a changing unit configured to change a position of the virtual viewpoint in accordance with an input received by the reception unit; and a control unit configured to move, in response to a specific condition being satisfied, a position of the virtual viewpoint to a position on a path determined in advance irrespective of the specific user operation.

### BACKGROUND OF THE INVENTION

### Field of the Invention

The present invention relates to a technique for setting a virtual viewpoint.

### Description of the Related Art

As a technique to reproduce a video image from a camera (virtual camera) not existing actually, which is arranged virtually within a three-dimensional space, by using video images captured by a plurality of real cameras, there is a virtual viewpoint image generation technique.

Viewpoint information on a virtual camera necessary for generation of a virtual viewpoint video image is set by a user inputting the movement direction, orientation, rotation, movement distance, moving speed, and the like of the virtual camera by using a controller, for example, such as a joystick, on a UI screen. In order to implement a smooth movement of the virtual camera in the target three-dimensional space, the meticulous operation of the controller is required and it is not easy to create a path (camera path) of the virtual camera of a stable locus. In relation to this point, Japanese Patent Laid-Open No. 2012-215934 has disclosed a technique to implement the stable behavior of a virtual camera by restricting the behavior of a moving body operated by a user in a case where a predetermined condition is satisfied and restricting the behavior of the virtual camera that follows the behavior of the moving body in accordance with the restriction.

However, the operability relating the setting of a virtual viewpoint is not sufficient. For example, in a case where a user operates a virtual camera by using a controller, such as a joystick, as described above, there is a possibility that the meticulous, complicated operation is required. Further, even though part of the behavior of the virtual camera is restricted, there is a possibility that the operability is still not sufficient.

### SUMMARY OF THE INVENTION

The information processing apparatus according to the present disclosure includes: a reception unit configured to receive an input in accordance with a specific user operation for changing a position of a virtual viewpoint for a virtual viewpoint image; a changing unit configured to change a position of the virtual viewpoint in accordance with an input received by the reception unit; and a control unit configured to move, in response to a specific condition being satisfied, a position of the virtual viewpoint to a position on a path determined in advance irrespective of the specific user operation.

Further features of the present invention will become apparent from the following description of exemplary embodiments with reference to the attached drawings.

### BRIEF DESCRIPTION OF THE DRAWINGS

FIG. 1A is a diagram showing a general configuration of an image processing system that generates a virtual viewpoint image and FIG. 1B is a diagram showing an example of a hardware configuration of an information processing apparatus;

FIG. 2 is a diagram showing an example of a software configuration relating to a camera path setting of the information processing apparatus;

FIG. 3A and FIG. 3B are each a diagram showing an example of a UI screen on which to set value ranges of camera parameters;

FIG. 4A and FIG. 4B are each a diagram showing an example of a UI screen for setting a virtual camera path according to a first embodiment;

FIG. 5 is a flowchart showing a flow of processing to control a transition from a free camera path into a fixed camera path according to the first embodiment;

FIG. 6A and FIG. 6B are each a diagram showing an example of a UI screen for operating a virtual camera according to a second embodiment;

FIG. 7 is a flowchart showing a flow of processing to control a transition from a free camera path into a fixed camera path according to the second embodiment; and

FIG. 8A and FIG. 8B are each a diagram showing the way a moving speed of a virtual camera changes.

### DESCRIPTION OF THE EMBODIMENTS

Hereinafter, with reference to the attached drawings, the present invention is explained in detail in accordance with preferred embodiments. Configurations shown in the following embodiments are merely exemplary and the present invention is not limited to the configurations shown schematically.

### First Embodiment

In a first embodiment, processing to automatically make a transition from a free movement of a virtual camera in which the virtual camera freely moves on a three-dimensional space into a restricted movement in which the virtual camera moves on a camera path is explained. In the present embodiment, for convenience of explanation, explanation is given by using the term “virtual camera”. The position of the virtual camera corresponds to the position of the virtual viewpoint, the orientation of the virtual camera corresponds to the orientation of the virtual viewpoint, and the zoom (focal length) of the virtual camera corresponds to the zoom parameter relating to the virtual viewpoint, respectively.

### (System Configuration)

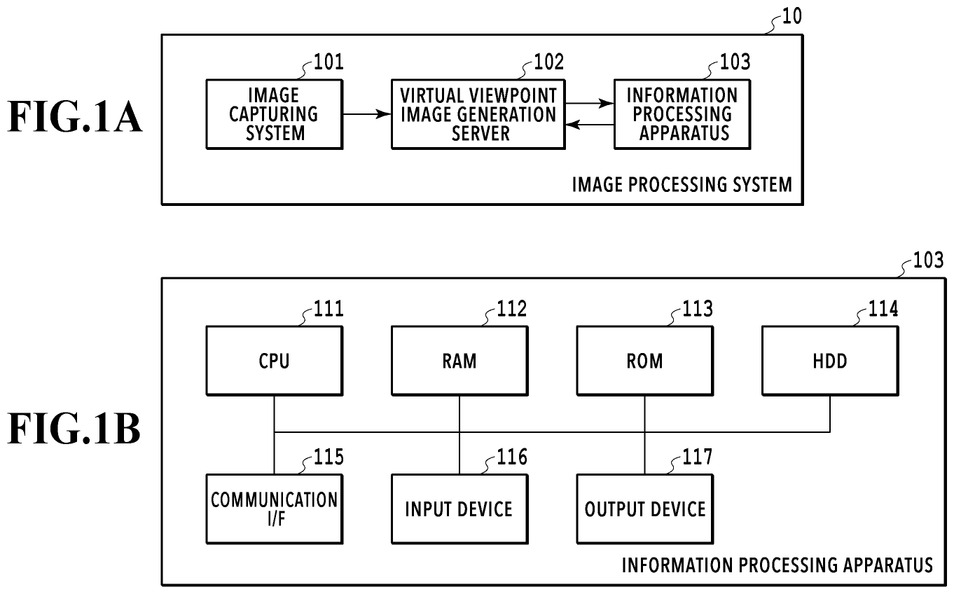

FIG. 1A is a diagram showing a general configuration of an image processing system capable of generating a virtual viewpoint image according to the present embodiment. An image processing system 10 has an image capturing system 101, a virtual viewpoint image generation server 102, and an information processing apparatus 103. The virtual viewpoint image is an image that is generated based on the position, orientation, and the like of a virtual camera different from a real camera and also called a free-viewpoint image and an arbitrary viewpoint image. The virtual camera may be controlled by the manual operation by an end user, an appointed operator, or the like, the automatic operation in accordance with the contents of a virtual viewpoint image, the automatic operation based on a cameral path (fixed camera path), which is a movement path of the virtual camera determined in advance, and the like. Further, the virtual viewpoint image may be a moving image or a still image. In the following, an example in a case where the virtual viewpoint image is a moving image is explained mainly.

The image capturing system 101 synchronously captures images from viewpoints in a plurality of directions by arranging a plurality of cameras at different positions, for example, within a stadium in which the athletic sports is performed. The data of a multi-viewpoint image obtained by the synchronous image capturing is transmitted to the virtual viewpoint image generation server 102.

The virtual viewpoint image generation server 102 generates a virtual viewpoint image viewed from a camera (virtual camera) that is different from any camera of the image capturing system 101 and which does not exist actually based on the multi-viewpoint image received from the image capturing system 101. The viewpoint of the virtual camera is represented by parameters (hereinafter, called “camera parameters”) specifying the viewpoint of the virtual camera, which are determined by the information processing apparatus 103, to be described later. The virtual viewpoint image generation server 102 sequentially generates the virtual viewpoint image based on the camera parameters received from the information processing apparatus 103.

The information processing apparatus 103 controls the virtual camera and determines camera parameters. The camera parameters include, for example, elements of the virtual camera, such as the position, orientation, zoom, and time. The position of the virtual camera is represented by three-dimensional coordinates and for example, indicated by the coordinates in the Cartesian coordinate system of the three axes of the X-axis, the Y-axis, and the Z-axis. The origin at this time may be an arbitrary position within the image capturing space. The orientation of the virtual camera is represented by, for example, the angles formed by the three axes of pan, tilt, and roll. The zoom of the virtual camera is represented by one axis of, for example, the focal length. The time is also represented by one axis like the zoom. That is, in a case of the camera parameters including the four kinds of element, that is, the position, the orientation, the zoom, and the time of the virtual camera, the camera parameters have eight elements. The camera parameters may include an element other than the four kinds of element described above and may not include all the elements of the eight axes described above. The determined camera parameters are transmitted to the virtual viewpoint image generation server 102 and a virtual viewpoint image in accordance with the camera parameters is generated by the virtual viewpoint image generation server 102.

### (Hardware Configuration of Information Processing Apparatus)

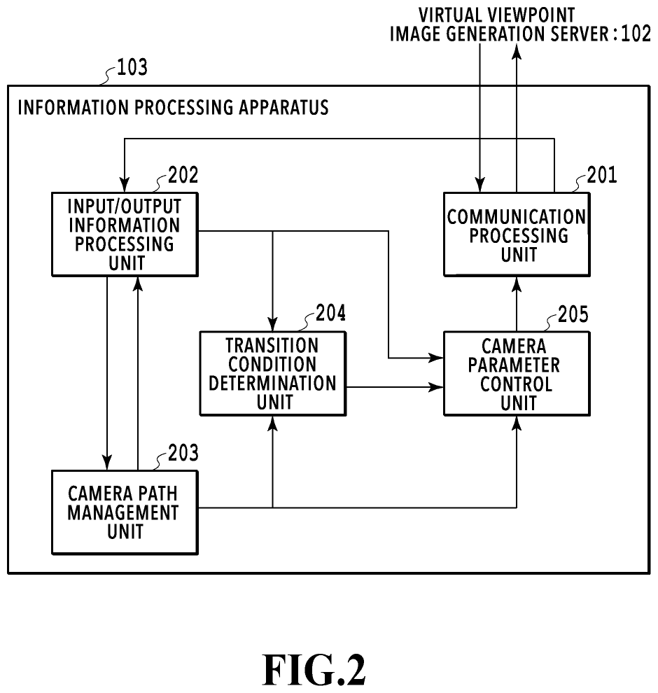

FIG. 1B is a diagram showing an example of the hardware configuration of the information processing apparatus 103. The information processing apparatus 103 has a CPU 111, a RAM 112, a ROM 113, an HDD 114, a communication I/F 115, an input device 116, and an output device 117. The CPU 111 is a processor that centralizedly controls each unit of the information processing apparatus 103 by executing various programs stored in the ROM 113 by using the RAM 112 as a work memory. By the CPU 111 executing the various programs, the function of each processing unit shown in FIG. 2, to be described later, is implemented. It may also be possible for the information processing apparatus 103 to have one or a plurality of pieces of dedicated hardware different from the CPU 111 or a GPU (Graphics Processing Unit) and for the GPU or the dedicated hardware to perform at least part of the processing of the CPU 111. As the example of the dedicated hardware, there are an ASIC (Application-Specific Integrated Circuit), a DSP (Digital Signal Processor), and the like. The RAM 112 temporarily stores programs read from the ROM 113, arithmetic operation results, data supplied from the outside via the communication I/F 114, and the like. The ROM 113 stores programs, such as the OS, and data, which do not need to be changed. The HDD 114 is a large-capacity storage device that stores various kinds of data, such as the fixed camera path described previously, and may be, for example, an SSD or the like. The fixed camera path described previously is configured by a plurality of camera parameters successive in a time series and the fixed camera path created in advance in accordance with the image capturing scene is stored. The communication I/F 115 is compatible with the communication standard, such as Ethernet and USB, and performs communication with the virtual viewpoint image generation server 102. The input device 116 includes controllers, such as a joystick, a foot pedal, a knob, and a jog dial, for operating the virtual camera, in addition to general devices, such as a keyboard and a mouse, for a user to perform the input operation. The output device 117 is one or a plurality of display devices (hereinafter, described as “monitor”) for displaying information necessary for a user. In a case where as the display device, for example, a touch panel display is adopted, the touch panel display also functions as the input device described above. On the monitor, a UI screen corresponding to the image capturing scene of the multi-viewpoint image is displayed and the path of the virtual camera is set on the UI screen.

### (Function Configuration of Information Processing Apparatus)

FIG. 2 is a diagram showing an example of the function configuration relating to the camera path setting of the information processing apparatus 103 and the information processing apparatus 103 has a communication processing unit 201, an input/output information processing unit 202, a camera path management unit 203, a transition condition determination unit 204, and a camera parameter control unit 205. In the present embodiment, the control to cause the virtual camera to automatically make a transition from the state where the virtual camera can be moved freely on the three-dimensional space into a fixed camera path prepared in advance. By each processing unit shown in FIG. 2 functioning in cooperation with one another, the above-described control is implemented. In the present specification, the camera path that is set in a state where the virtual camera can be moved freely is called “free camera path”. Even in the state where the virtual camera can be moved freely, a part of the movement range of the virtual camera may be restricted because of privacy or in accordance with another restriction.

The communication processing unit 201 sequentially transmits the camera parameters generated by a camera parameter control unit 118 to the virtual viewpoint image generation server 102 via the communication I/F 115. Further, a part or all of the camera parameters are also sent to the input/output information processing unit 202. Further, the communication processing unit 201 delivers the data of the virtual viewpoint image generated by the virtual viewpoint image generation server 102 to the input/output information processing unit 202 via the communication I/F 115.

An operator of the virtual camera gives instructions as to the movement direction, the amount of movement, and the like of the virtual camera by operating the controller (for example, tilting the joystick) while watching a UI screen, to be described later. The input/output information processing unit 202 sequentially acquires the input values (in a case of the joystick, the direction and angle of the tilt) in accordance with the operation and generates camera parameters based on the acquired input values. The generated camera parameters are sent to the camera path management unit 203 and the transition condition determination unit 204. Further, the input/output information processing unit 202 displays the image data and information received from the communication processing unit 201 on the monitor. Specifically, the input/output information processing unit 202 displays the received virtual viewpoint image, state information on the virtual camera, which represents the camera parameters, the locus of the virtual camera on the fixed camera path read from the camera path management unit 203, and the like on the UI screen. It is made possible for an operator of the virtual camera to operate the virtual camera by using the joystick and the like while watching the information displayed on the monitor. Further, the input/output information processing unit 202 sets a predetermined condition (hereinafter, described as “transition condition”) at the time of causing the virtual camera to make a transition from the state where it is possible for an operator to freely move the virtual camera into a fixed camera path prepared in advance. The transition condition is a determination condition of whether or not to switch the virtual camera to a fixed camera path and after a transition is made into the fixed camera path, the free operation of the virtual camera is restricted, and in this meaning, it is possible to regard the transition condition as a restriction condition. In the following, examples of the transition condition are described. However, the contents of the transition condition are not limited to those. Further, the transition condition may be a combination of a plurality of conditions.
A case where the current position of the virtual camera approaches the reference position on the fixed camera path (position on the three-dimensional space in one of the key frames) within a predetermined distance
A case where the current orientation of the virtual camera becomes an orientation that matches or resembles the reference orientation on the fixed camera path (the line-of-sight direction in one of the key frames)
A case where the current movement direction of the virtual camera becomes a movement direction along the fixed camera path

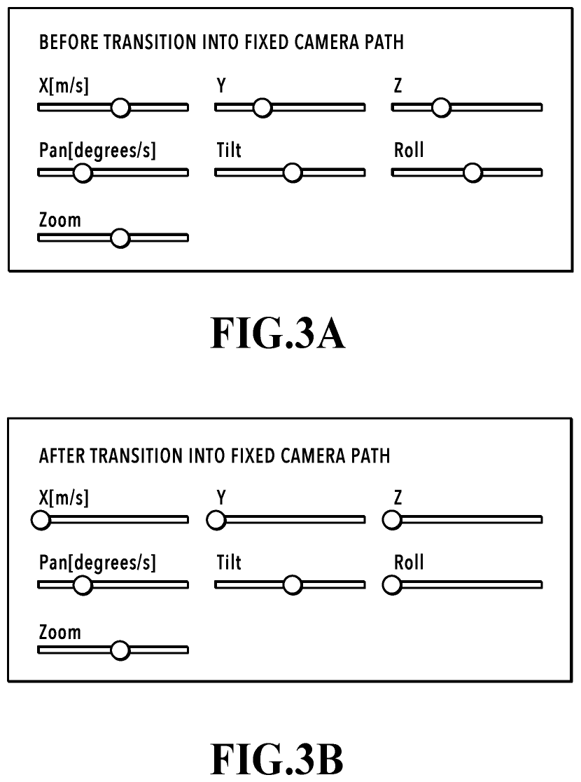

After the above-described transition condition is satisfied and the free camera path changes into the fixed camera path, a predetermined restriction is imposed on the operation of the virtual camera. That is, the virtual camera moves along a path specified by the fixed camera path and it is made possible to operate the virtual camera only on the path. In relation to this, it may also be possible to set in advance a value range (width by which each element can change) that each camera parameter can take before and after the transition into the fixed camera path. FIG. 3A and FIG. 3B each show an example of the UI screen on which to set value ranges of camera parameters. On the UI screen in FIG. 3A, the value ranges that are applied before the transition into the fixed camera path are set (at the time of free camera path). Then, on the UI screen in FIG. 3B, the value ranges that are applied after the transition into the fixed camera path are set. Here, it is made possible to set the value ranges of the three axes (X, Y, Z) representing the position of the virtual camera, the three axes (pan, tilt, roll) representing the orientation of the virtual camera, and the zoom (focal length) of the virtual camera. It is possible for a user to set an arbitrary value range by adjusting the knob on the slide bar provided for each axis of the element. On this UI screen, the right end of the slide bar is the maximum amount of change and the left end is the minimum amount of change (amount of change=zero). As shown in FIG. 3A, before the transition into the fixed camera path, the value ranges of all the parameters are set to zero or more. In contrast to this, after the transition into the fixed camera path, the value ranges of the three axes representing the position of the virtual camera and the roll are set to the zero amount of change and an operator is restricted from freely performing the operation of the positions (X, Y, Z) and the roll. That is, after the transition, it is made possible to perform the operation to change only the pan, tilt, and zoom while moving the virtual camera on the fixed camera path. The movement of the virtual camera on the fixed camera path may be performed automatically and in the movement direction along the fixed camera path, the movement of the virtual camera in accordance with the user operation may be permitted. Further, it may also be possible to perform the setting to make invalid the operation itself for a specific element in place of setting the value range to the zero amount of change for the specific element after the transition.

The camera path management unit 203 sequentially stores the camera parameters received from the input/output information processing unit 202 in the HDD 114. Further, the camera path management unit 203 reads the fixed camera path from the HDD 114 and outputs the fixed camera path to the input/output information processing unit 202, the transition condition determination unit 204, and the camera parameter control unit 205.

The transition condition determination unit 204 determines whether or not the above-described transition condition is satisfied based on the camera parameters at the current point in time, which are input from the input/output information processing unit 202, and the read fixed camera path. Determination results are output to the camera parameter control unit 205 along with the input camera parameters. Further, the transition condition determination unit 204 also performs processing to update the transition condition based on the input value in accordance with the operation of the input device 116, which are received from the input/output information processing unit 202. For example, the transition condition determination unit 204 changes the threshold value that specifies the above-described “predetermined distance” in accordance with the amount of rotation of a knob, not shown schematically.

The camera parameter control unit 205 performs processing to determine camera parameters for connecting the current position of the virtual camera and the fixed camera path based on the determination results by the transition condition determination unit 204. First, in a case where the determination results are “transition condition is satisfied”, the camera parameter control unit 205 performs generation or the like of camera parameters for filling in up to the connection destination on the fixed camera path prepared in advance (key frame on the fixed camera path nearest from the current position of the virtual camera). On the other hand, in a case where the determination results are “transition condition is not satisfied”, the camera parameter control unit 205 outputs the camera parameters representing the current position of the virtual camera, which are input from the transition condition determination unit 204, to the communication processing unit 201 without changing them. In the generation processing of the camera parameters for connecting to the fixed camera path, the value range that each element can take shown in FIG. 3B described previously is taken into consideration. Further, in a case where the range in which the virtual camera can move without being restricted by the fixed camera path is specified, the generation processing is performed so that the virtual camera is within the range (within the range of the permitted value given to each of the three axes representing the position of the virtual camera). Further, it may also be possible to take only the specific element specified by an operator as the generation target among the elements configuring the camera parameters and take a part of the elements as fixed values.

(Automatic Transition into Fixed Camera Path)

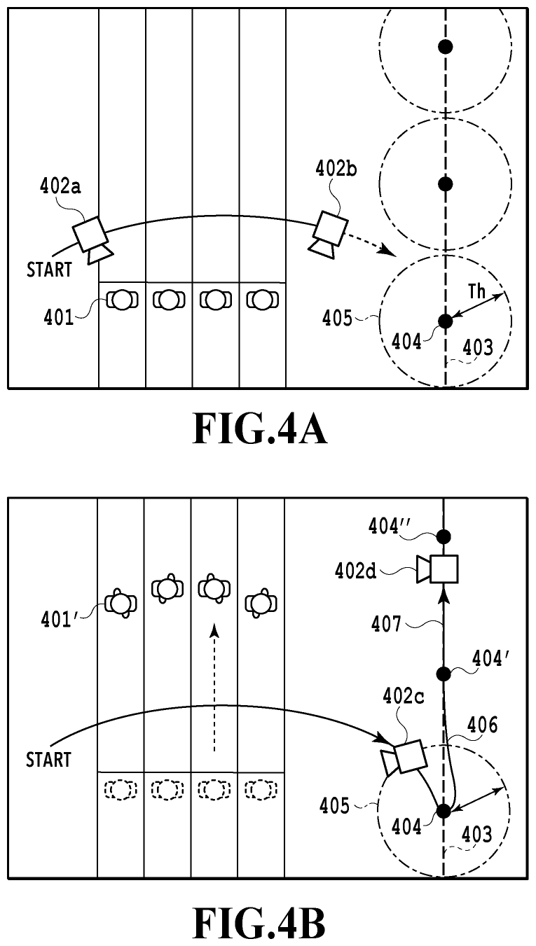

Here, an application example of the present embodiment in a case where the image capturing scene is a short-distance race of the athletic sports is explained. In the short-distance race of the athletic sports, a camera path is supposed in which the virtual camera is moved so as to capture the figures of athletes running on the respective determined courses from the side by following the athletes, after capturing the athletes in order standing side by side on the start line from the front. Consequently, an example is explained in which control is performed so that the free camera path in which the virtual camera can be moved freely is adopted in a case of capturing each athlete before the start and the free camera path is switched to the fixed camera path in which the virtual camera captures the figures of the running athletes from the side after the start. Here, it is assumed that the operation to move the virtual camera is performed by the joystick as a controller. FIG. 4A and FIG. 4B are each a diagram showing an example of a path setting UI screen of the virtual camera used by an operator in a case where the present embodiment is applied to the scene of the short-distance race of the athletic sports as a target. On the UI screens shown in FIG. 4A and FIG. 4B, on a plane image in a case where the vicinity of the start area of the course on which athletes 401 run is viewed from a bird□s eye, a mark 402 indicating the position of the virtual camera is displayed. Then, within the UI screen, a dotted line 403 indicating the fixed camera path is also displayed in an overlapping manner. By using the UI screen such as this, an operator performs the operation to move the virtual camera while grasping the position in the image capturing target-three-dimensional space. The display of the fixed camera path in an overlapping manner is only required to be a display aspect in which it is possible to grasp the position relationship with the virtual camera and not limited to the dotted line. For example, it may also be possible to highlight the fixed camera path by, for example, coloring the fixed camera path so as to be capable of distinguishing it from an existing object.

FIG. 4A shows the locus (free camera path) of the position of the fixed camera path before the athletes start and FIG. 4B shows switching from the free camera path to the fixed camera path after the athletes start and the locus of the position of the virtual camera after that. As shown in FIG. 4A, in the state before the athletes start, an operator moves the virtual camera so that the virtual camera moves along a gradual arc from a position 402a to a position 402b in order to capture the athletes 401 standing by at the start position in order from the front. Then, immediately before the start, the operator further moves the virtual camera toward a fixed camera path 403. Then, in a case where the virtual camera approaches the key frame indicated by a black circle 404 on the virtual camera 403 within a predetermined distance, the virtual camera is connected to the fixed camera path 403. At this time, like the fixed camera path 403, the key frame 404 and the range of the predetermined distance are also displayed on the UI screen in an overlapping manner so that the operator can recognize. In FIG. 4A, the range indicated by a circle 405 (radius=threshold value Th) with the position of each key frame 404 as a center indicates the predetermined distance. As this threshold value Th, an arbitrary value is set by a user, such as the operator. Here, the predetermined distance is indicated two-dimensionally, but it is needless to say that the predetermined distance actually specifies the range of the space having a three-dimensional volume. For example, in a case of a UI screen based on the virtual viewpoint image, it may also be possible to indicate the predetermined distance three-dimensionally.

For the connection to the fixed camera path, as shown in FIG. 4B, camera parameters that fills in between a position 402c and the position 404 of the key frame are acquired by interpolation processing using, for example, a spline function, and thereby, the virtual camera is smoothly connected to the fixed camera path 403. That is, the position of the virtual camera moves continuously to the position on the fixed camera path 403. Then, after the athletes 401 start, the position of the key frame moves over time along the fixed camera path 403 so as to follow athletes 401 □(position 402d) and the virtual camera also moves in an interlocking manner with the key frame. At this time, in accordance with the movement of the virtual camera, camera parameters between the key frames are obtained by interpolation processing. In the example in FIG. 4B, from the position 404 to a position 404 □ of the next key frame, camera parameters represented by a solid line 406 slightly shifted from the fixed camera path 403 are generated. Then, further, from the position 404 □to a position 404″ of the next key frame, camera parameters represented by a solid line 407 that overlaps the fixed camera path 403 are generated. By including the element of the moving speed in each camera parameter configuring the fixed camera path 403, after the transition into the fixed camera path 403, it is possible to move the virtual camera in accordance with the fixed camera path 403 irrespective of the operation of the controller by an operator. The moving speed of the virtual camera is determined by the intervals (degree of fineness) of arrangement of camera parameters at the time of creation of the fixed camera path 403.

As will be described in a second embodiment, it may also be possible to design a configuration in which an operator of the virtual camera can control the moving speed of the virtual camera separately on the fixed camera path 403. Further, on the UI screens shown in FIG. 4A and FIG. 4B, the bird□s eye image is used, but it may also be possible to use a virtual viewpoint image. That is, it may also be possible to operate the virtual camera by adopting an image obtained by composing the line representing the locus of the fixed camera path 403 and the mark representing the current position of the virtual camera with the background 3D model of the sports stadium as a UI screen. In this case, the background 3D model of the sports stadium is, for example, a CG (Computer Graphics) model of the sports stadium or the like in which the image capturing system 101 is installed, and it is sufficient to create in advance the background 3D model and save it in the HDD 114 of the information processing apparatus 103.

(Transition Control into Fixed Camera Path)

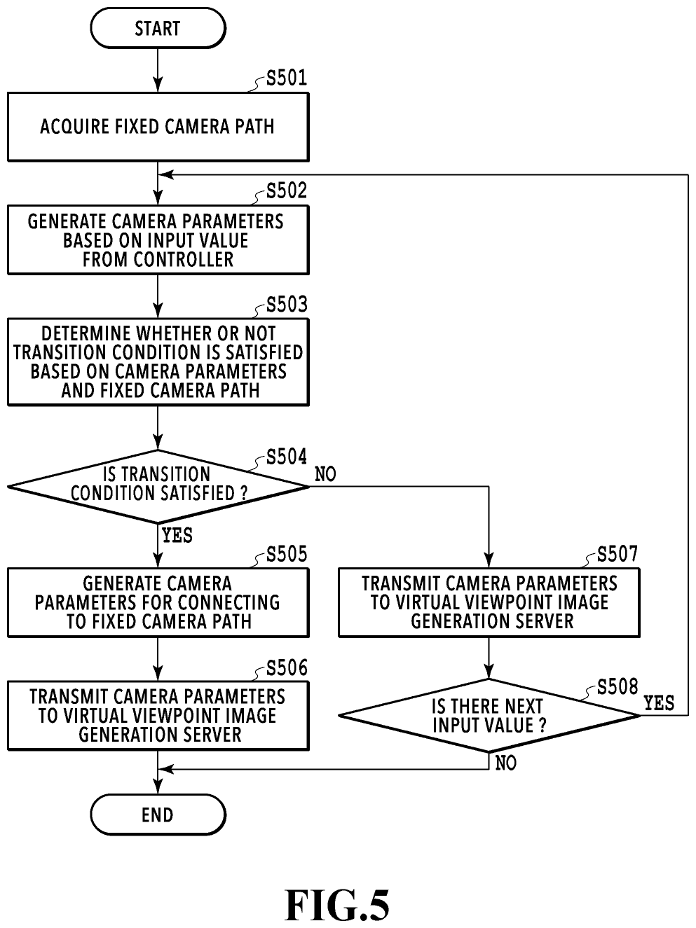

FIG. 5 is a flowchart showing a flow of processing to control the transition from the free camera path into the fixed camera path according to the present embodiment. The flow shown in FIG. 5 is implemented by the control program stored in the ROM 113 being read onto the RAM 112 and being executed by the CPU 111. Execution of the flow in FIG. 5 is started as instructions to start generation of a virtual viewpoint image from a user (operator) as a trigger.

At S501, the transition condition determination unit 204 acquires the data of the fixed camera path prepared in advance via the camera path management unit 203. At S502 that follows, the input/output information processing unit 202 generates camera parameters based on the input value in accordance with the operation of the controller by an operator. At the point in time immediately after the start of this flow, camera parameters indicating the start position (initial value of the camera path) of image capturing by the virtual camera are generated. The generated camera parameters are sent to the transition condition determination unit 204.

At S503, the transition condition determination unit 204 determines whether or not the transition condition into the fixed camera path is satisfied based on the fixed camera path acquired at S501 and the camera parameters generated at S502. As the transition condition at this time, it may also be possible to use one prepared in advance by reading it from the HDD 114 or the like or to display a transition condition setting UI screen (not shown schematically) before the start of execution of this flow and use one specified by an operator via the UI screen. The determination results are sent to the camera parameter control unit 205 along with the camera parameters used for the determination and the data of the fixed camera path.

At S504, the camera parameter control unit 205 branches the processing in accordance with the determination results at S503. Specifically, in a case where the determination results are that the transition condition is satisfied, the processing advances to step S505 and in a case where the determination results are that the transition condition is not satisfied, the processing advances to step S507.

At S505, the camera parameter control unit 205 connects the current position of the virtual camera and the fixed camera path based on the camera parameters and the fixed camera path, which are input. Specifically, the camera parameter control unit 205 performs, for example, interpolation processing using a spline function and generates camera parameters that fill in therebetween so that the current position of the virtual camera is connected smoothly to the key frame, which is the target of the fixed camera path. Alternatively, it may also be possible to interpolate camera parameters so that the current position of the virtual camera is connected linearly to the key frame, which is the target. It may also be possible to jump the current position of the virtual camera to the key frame, which is the target. Due to this, one or a plurality of camera parameters that fill in up to the key frame of the fixed camera path is obtained, in addition to the camera parameters representing the current position/orientation of the virtual camera generated at S502. The obtained camera parameters are delivered to the communication processing unit 201. In a case where the transition condition is satisfied, it may also be possible for the camera parameter control unit 205 to move only the position of the virtual camera to the position of the key frame or to change the orientation of the virtual camera to the orientation set to the key frame. Further, in a case where a plurality of key frames is set on the fixed camera path, it may also be possible to move the virtual camera to the position of the nearest key frame among the positions of the plurality of key frames in response to the transition condition being satisfied.

At S506, the communication processing unit 201 transmits the camera parameters obtained at S505 to the virtual viewpoint image generation server 102. Then, in the virtual viewpoint image generation server 102, generation of a virtual viewpoint image based on the camera parameters received from the information processing apparatus 103 is performed. After the transition into the fixed camera path, at the point in time at which the last of the successive camera parameters configuring the fixed camera path is reached, control is performed so that the state where the virtual camera can move freely is returned. Alternatively, it may also be possible to design a configuration in which it is possible to terminate the processing on the way of the fixed camera path by explicit instructions by an operator via the controller or the like.

At S507, the communication processing unit 201 transmits the camera parameters generated at S502 to the virtual viewpoint image generation server 102. Then, in the virtual viewpoint image generation server 102, generation of a virtual viewpoint image based on the camera parameters received from the information processing apparatus 103 is performed. At S508 that follows, the processing is branched in accordance with the presence/absence of a new input value from the controller by an operator. In a case where a new input value is recognized, the processing returns to S502 and camera parameters based on the new input value are generated. On the other hand, in a case where an input value from the controller is not expected, such as a case where instructions to terminate generation of a virtual viewpoint image by an operator are received, this flow is terminated.

The above is the contents of the transition control from the free camera path into the fixed camera path according to the present embodiment.

### Modification Example

Further, in the present embodiment, the transition condition from the free camera path into the fixed camera path is whether or not the virtual camera approaches the position in the key frame of the fixed camera path within a predetermined distance with the position on the three-dimensional space of the virtual camera as a reference, but this is not limited. For example, it may also be possible to take whether or not the orientation of the virtual camera matches or resembles the orientation in the key frame of the fixed camera path as the transition condition. Further, in the present embodiment, the transition condition is explained by using the representation, such as “position in the key frame” and “orientation in the key frame”, but the representation is not limited to the key frame. That is, it may also be possible to make a transition from the free camera path into the fixed camera path in a case where the position of the virtual camera enters a range set in advance, or it may also be possible to make a transition from the free camera path into the fixed camera path in a case where the orientation of the virtual camera becomes within a range of orientation set in advance. Further, it may also be possible to make a transition from the free camera path into the fixed camera path in a case where both the conditions of the position and orientation are satisfied. Furthermore, it may also be possible to take a predetermined operation by an operator, pressing down of a dedicated button, selection of the fixed camera path on the UI screen, or the like as the transition condition. The transition condition may be a combination of a plurality of conditions.

Further, in the present embodiment, explanation is given by taking a case as an example where there is one fixed camera path, but it is also considered that a plurality of fixed camera paths is prepared in advance. For example, in a case where the transition condition for the plurality of fixed camera paths is satisfied at the same time, it is sufficient to make a transition into the fixed camera path whose degree of matching of the element (position, orientation, movement direction of the virtual camera) that is the determination target of the transition condition is higher.

As explained above, in the present embodiment, in a case where a predetermined condition is satisfied in the state where an operator freely moves the position of the virtual camera, processing to automatically make a transition into the fixed camera path is performed. Due to this, it is made possible to set a camera path of a stable locus, which also makes effective use of a high feeling of being at a live performance of a virtual viewpoint image.

### Second Embodiment

In the first embodiment, the aspect is explained in which in a case where the virtual camera that is moved freely by using the controller approaches the fixed camera path within a predetermined distance, the virtual camera is caused to automatically make a transition into the fixed camera path. Next, an aspect is explained as a second embodiment in which in the state where the virtual camera is moved freely by a first controller, the virtual camera is caused to make a transition into the fixed camera path in response to a second controller being operated. Explanation of the portions in common to those of the first embodiment, such as the system configuration, is omitted or simplified and in the following, setting processing of a camera path, which is a different point, is explained mainly.

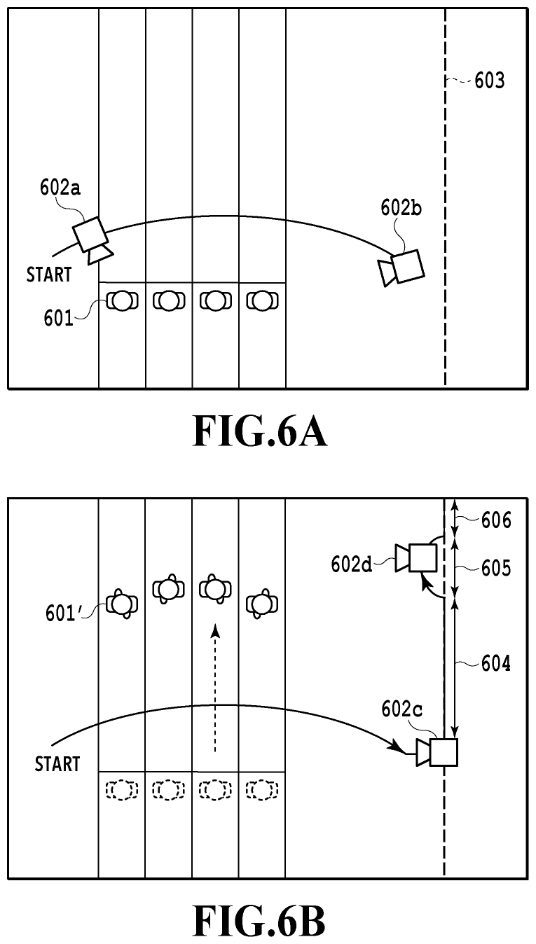

FIG. 6A and FIG. 6B are diagrams corresponding to FIG. 4A and FIG. 4B of the first embodiment. In FIG. 6A, the locus of the position of the virtual camera before athletes start is shown and in FIG. 6B, the locus of the position of the virtual camera after the athletes start is shown.

As shown in FIG. 6A, before the start, the virtual camera moves along a gradual arc from a position 602a to a position 602b so as to capture athletes 601 located at the start position from the front. The movement up to the position 602b is the operation by the joystick as the first controller. Then, it is assumed that an operator performs a predetermined operation, such as an operation to step on a foot pedal as the second controller until, for example, 90% (first threshold value) of the maximum step-on amount is exceeded, at timing at which the athletes start to run. In this case, as shown in FIG. 6B, the virtual camera moves to an arbitrary position of a fixed camera path 603 (here, a position 602c nearest from the current position of the virtual camera) and is connected to the fixed camera path. In a case where information on the key frame is included in the fixed camera path 603, the position may be the nearest key frame. That is, in the present embodiment, the transition condition determination unit 204 determines whether or not the transition condition is satisfied based on the input value itself from the controller. Then, in a case where it is determined that the transition condition is satisfied, by complementation processing that takes the position 602c as a target, camera parameters that fill in between the position 602b and the position 602c are acquired, and thereby, the virtual camera is connected smoothly to the fixed camera path 603. Then, in a case where the operator keeps the step-on amount of the foot pedal at 50% (second threshold value) or more of the maximum step-on amount, the virtual camera moves on the camera path 603 in the meanwhile. Then, in a case where the operator reduces the step-on amount of the foot pedal to the second threshold value or less, the virtual camera disassociates from the fixed camera path 603 and it is made possible again to move the virtual camera freely by the joystick. That is, in the present embodiment, the transition condition determination unit 204 further performs processing to determine whether or not a disassociation condition from the fixed camera path is satisfied based on the input value from the second controller. In response to the disassociation condition being satisfied, the restriction on the operation of the virtual camera is removed. In FIG. 6B, bidirectional arrows 604 and 606 indicate sections on the fixed camera path 603 in a case where the foot pedal is kept being stepped on by 50% or more of the maximum step-on amount. Further, a bidirectional arrow 605 indicates a section in which the virtual camera disassociates from the fixed camera path 603 and can move freely in a case where the step-on amount of the foot pedal is reduced to 50% or less of the maximum step-on amount.

(Transition Control into Fixed Camera Path)

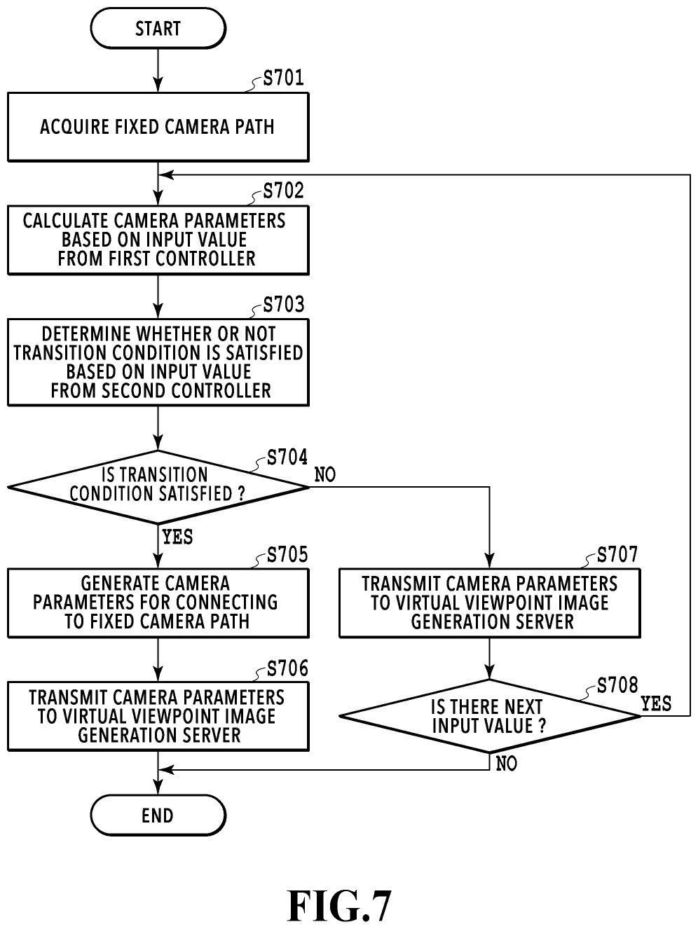

FIG. 7 is a flowchart showing a flow of processing to control the transition from the free camera path into the fixed camera path according to the present embodiment. With instructions to start generation of a virtual viewpoint image from a user (operator) as a trigger, execution of the flow in FIG. 7 is started.

S701 and S702 correspond to S501 and S502 respectively in the flow in FIG. 5 of the first embodiment. That is, the data of the fixed camera path prepared in advance is acquired (S701) and following this, camera parameters are generated (S702) based on the input value in accordance with the operation of the first controller (here, joystick) by an operator.

At S703, the transition condition determination unit 204 determines whether or not the transition condition into the fixed camera path is satisfied based on the input value in accordance with the operation of the second controller (here, foot pedal) by an operator. As the transition condition at this time (first threshold value described previously), it may also be possible to use one prepared in advance by reading it from the HDD 114 or the like or to display a transition condition setting UI screen (not shown schematically) before the start of execution of this flow and use one specified by an operator via the UI screen. The determination results are sent to the camera parameter control unit 205 along with the camera parameters generated at S702 and the data of the fixed camera path acquired at S701.

S704 to S708 correspond to S704 to S708 respectively in the flow in FIG. 5 of the first embodiment and there is not a difference in particular, and therefore, explanation is omitted.

The above is the contents of the transition control from the free camera path into the fixed camera path according to the present embodiment.

### Modification Example

In the present embodiment, by the operation to step on the foot pedal, which is the second controller, the transition into the fixed camera path and the disassociation from the fixed camera path are controlled, but the control is not limited to this. For example, it may also be possible to control the transition and the disassociation in accordance with pressing down of a button provided to the joystick, which is the first controller. Then, it may also be possible to control the moving speed, the movement distance, and the like while the virtual camera exists on the fixed camera path by the foot pedal, which is the second controller.

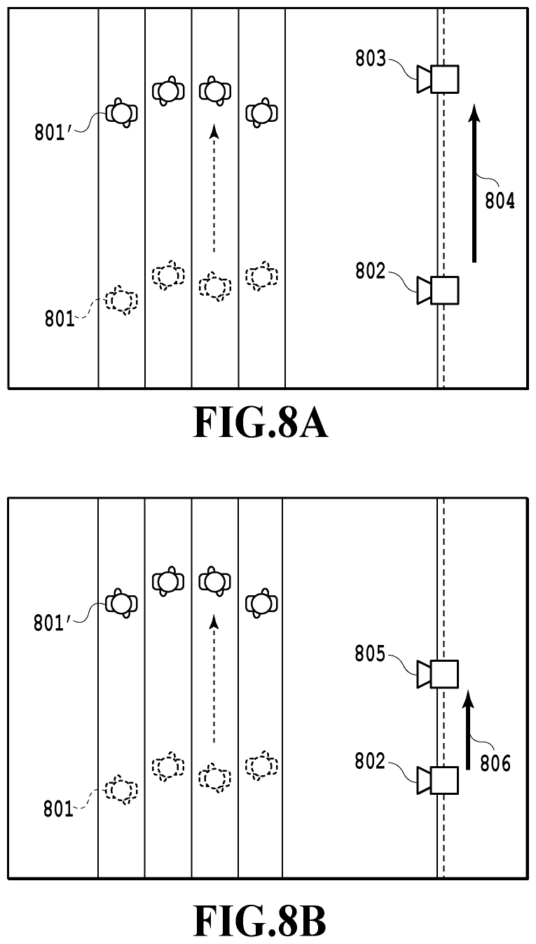

In the present embodiment, the configuration is designed so that the disassociation from the fixed camera path is enabled in a case where the step-on amount of the foot pedal becomes less than or equal to the second threshold value, but it may also be possible to change the moving speed of the virtual camera on the fixed camera path in accordance with the step-on amount of the foot pedal in place of the disassociation function. For example, by performing sampling of the camera parameter every other time, it is possible to double the speed at which the virtual camera moves on the fixed camera path. FIG. 8A and FIG. 8B are diagrams showing the way the moving speed of the virtual camera changes by the step-on amount of the foot pedal while an athlete is running. FIG. 8A corresponds to a case where the foot pedal is stepped on fully (maximum step-on amount) and FIG. 8B corresponds to a case where the foot pedal is returned to the middle point (50% of the maximum step-on amount). In a case of FIG. 8A, while the athlete runs from a position 801 to a position 801, □the virtual camera moves from a position 802 to a position 803 on the fixed camera path. An arrow 804 indicates the movement distance at this time. In contrast to this, in a case of FIG. 8B, while the athlete runs from the position 801 to the position 801I the virtual camera moves from the position 802 only to a position 805 on the fixed camera path and the length of an arrow 806 indicating the movement distance is half that of the arrow 804 in FIG. 8A. That is, in a case of this example, in FIG. 8B, the moving speed of the virtual camera is half that in a case of FIG. 8A. It may also be possible to design a configuration in which in a case where an operator completely returns the foot pedal to the original position (in a case where an operator stops stepping on the foot pedal), the movement distance becomes zero (the virtual camera stops on the fixed camera path). Here, the example is explained in which as the step-on amount of the foot pedal increases, the moving speed of the virtual camera increases, but the example is not limited to this. For example, it may also be possible to take a case where an operator does not step on the foot pedal as the state of the maximum moving speed of the virtual camera and a case where an operator fully steps on the foot pedal as the still state of the virtual camera. In a case of this modification example, by changing the step-on amount of the foot pedal in accordance with a change in the speed at which an athlete runs, it is made possible to cause the movement of the virtual camera to follow the athlete with the restriction on the movement on the fixed camera path.

According to the present embodiment, in the state where the virtual camera is moved freely by using the first controller, by performing the operation using the second controller, processing to cause the virtual camera to make a transition so as to be pulled to the fixed camera path is performed. By the processing such as this, it is made possible to cause the virtual camera to make a smooth transition into the fixed camera path from any position on the target three-dimensional space.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a □non-transitory computer-readable storage medium□) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)□), a flash memory device, a memory card, and the like.

According to the present invention, the operability relating the setting of a virtual viewpoint improves.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-208993, filed Nov. 6, 2018 which is hereby incorporated by reference wherein in its entirety.

What is claimed is:

1. An information processing apparatus comprising:
a reception unit configured to receive an input in accordance with a specific user operation for changing a position of a virtual viewpoint for a virtual viewpoint image;
a changing unit configured to change a position of the virtual viewpoint in accordance with an input received by the reception unit; and
a control unit configured to move, in response to a specific condition being satisfied, a position of the virtual viewpoint to a position on a path determined in advance irrespective of the specific user operation.

2. The information processing apparatus according to claim 1, wherein
the control unit continuously moves a position of the virtual viewpoint to a position on the path.

3. The information processing apparatus according to claim 1, wherein
the control unit moves a position of the virtual viewpoint to a specific position on the path in response to the specific condition being satisfied and
the specific position moves over time along the path.

4. The information processing apparatus according to claim 1, wherein
the control unit moves a position of the virtual viewpoint to a predetermined position nearest to the current position of the virtual viewpoint among a plurality of predetermined positions on the path in response to the specific condition being satisfied.

5. The information processing apparatus according to claim 1, wherein
the specific user operation is an operation to specify a movement direction of the virtual viewpoint by using a controller.

6. The information processing apparatus according to claim 1, wherein
the reception unit receives an input in accordance with a second specific user operation for changing an orientation of the virtual viewpoint for the virtual viewpoint image,
the changing unit changes an orientation of the virtual viewpoint in accordance with an input received by the reception unit, and
the control unit changes an orientation of the virtual viewpoint to an orientation determined in advance irrespective of the second specific user operation in response to the specific condition being satisfied.

7. The information processing apparatus according to claim 1, wherein
the control unit moves a position of the virtual viewpoint in response to the specific condition concerning a relationship between a position of the virtual viewpoint and the path being satisfied.

8. The information processing apparatus according to claim 1, wherein
the specific condition includes a condition that a position of the virtual viewpoint approaches within a predetermined range from a position on the path.

9. The information processing apparatus according to claim 1, wherein
the specific condition includes a condition that an orientation of the virtual viewpoint matches or resembles an orientation determined in advance.

10. The information processing apparatus according to claim 1, wherein
the specific condition includes a condition that a movement direction of the virtual viewpoint is a movement direction along the path.

11. The information processing apparatus according to claim 1, wherein
the specific condition includes a condition that a predetermined user operation different from the specific user operation is performed.

12. The information processing apparatus according to claim 1, further comprising:
a restriction unit configured to restrict at least part of a change in a position of the virtual viewpoint in accordance with the specific user operation after a position of the virtual viewpoint moves to a position on the path.

13. The information processing apparatus according to claim 12, wherein
the restriction unit restricts a change in a position of the virtual viewpoint in accordance with the specific user operation to a movement direction along the path.

14. The information processing apparatus according to claim 12, wherein
the restriction unit restricts at least part of a change in an orientation of the virtual viewpoint in accordance with a user operation.

15. The information processing apparatus according to claim 12, further comprising:
a removal unit configured to remove a restriction by the restriction unit in response to another specific condition different from the specific condition being satisfied.

16. The information processing apparatus according to claim 1, further comprising:
an output unit configured to output information indicating a position of the virtual viewpoint to an image generation apparatus that generates the virtual viewpoint image based on a plurality of images obtained by performing image capturing from directions different from one another by a plurality of image capturing apparatuses.

17. A control method comprising:
receiving an input in accordance with a specific user operation for changing a position of a virtual viewpoint for a virtual viewpoint image;
changing a position of the virtual viewpoint in accordance with the received input; and
moving, in response to a specific condition being satisfied, a position of the virtual viewpoint to a position on a path determined in advance irrespective of the specific user operation.

18. The control method according to claim 17, wherein
in control, a position of the virtual viewpoint moves continuously to a position on the path.

19. The control method according to claim 17, wherein
in the control, a position of the virtual viewpoint moves in response to the specific condition concerning a relationship between a position of the virtual viewpoint and the path being satisfied.

20. A non-transitory computer readable storage medium storing a program for causing a computer to perform a control method, the control method comprising:
receiving an input in accordance with a specific user operation for changing a position of a virtual viewpoint for a virtual viewpoint image;
changing a position of the virtual viewpoint in accordance with the received input; and
moving, in response to a specific condition being satisfied, a position of the virtual viewpoint to a position on a path determined in advance irrespective of the specific user operation.
